(19) United States
(12) Patent Application Publication
(10) Pub. No.: US 2009/0296995 A1
(43) Pub. Date: Dec. 3, 2009

(54) INFORMATION PROCESSING APPARATUS AND CONTROL METHOD THEREOF, AND WORKFLOW PROCESSING SYSTEM

(75) Inventor: Yuichiro Shibuya, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/476,592

(22) Filed: Jun. 2, 2009

(30) Foreign Application Priority Data
Jun. 3, 2008 (JP) 2008-146217

(51) Int. Cl. G06K 9/00; G06F 21/00; G06F 15/16

(52) U.S. Cl. 382/115; 726/2; 709/203

(57) ABSTRACT

To realize a paper-based workflow that is easy for a user to understand and that reduces security-related problems, an information processing apparatus includes a receiving unit that receives, from an external apparatus, form image data in which multiple input items have been arranged in advance and authority information data containing user authority information for each of the items arranged in the form image data; an authentication unit that performs user authentication and generates user authentication information; and an output image generation unit that generates output form image data in which the areas corresponding to one or more of the input items contained in the form image data have been masked, based on the user authentication information and user authority information regarding referencing contained in the authority information data.

### BACKGROUND OF THE INVENTION

1. Field of the Invention

The present invention relates to an information processing technique for workflow processing.

2. Description of the Related Art

Forms and the like used in workflows such as office tasks, various types of applications, and so on are created as exhaustive documents so that multiple users can fill out and refer to them. For this reason, there are generally large numbers of items included in such forms, and thus it has been difficult for users filling out such forms to determine which areas in the form to fill out, and in what manner. There is the possibility of an additional security risk, in that the personal information of a given user can be referred to by other users. Accordingly, Japanese Patent Laid-Open No. H8-185349 discloses a computer system for setting the security levels of individual items in a record with ease.

However, the same problem as mentioned above occurs in cases where an environment lacking a client PC for directly referring to/changing electronic data exists within a workflow. In other words, when processing using paper-based forms is necessary, the forms can easily become complicated for the user, leading to the possibility of security-related problems arising.

### SUMMARY OF THE INVENTION

According to one aspect of the present invention, an information processing apparatus, comprises: a receiving unit that receives, from an external apparatus, form image data in which multiple input items have been arranged in advance and authority information data containing user authority information for each of the items arranged in the form image data; an authentication unit that performs user authentication and generates user authentication information; and an output image generation unit that generates output form image data in which the areas corresponding to one or more of the input items contained in the form image data have been masked, based on the user authentication information and user authority information regarding referencing contained in the authority information data.

According to another aspect of the present invention, a control method for an information processing apparatus, the method comprises the steps of: receiving, from an external apparatus, form image data in which multiple input items have been arranged in advance and authority information data containing user authority information for each of the items arranged in the form image data; performing user authentication and generating user authentication information; and generating output form image data in which the areas corresponding to one or more of the input items contained in the form image data have been masked, based on the user authentication information and user authority information regarding referencing contained in the authority information data.

According to still another aspect of the present invention, a workflow processing system includes a management server that manages workflow processing, and a client terminal comprising an image forming unit and an image reading unit, the management server and the client terminal being connected to each other via a network, wherein the management server comprises: a management unit that manages form image data in which multiple input items have been arranged in advance and authority information data containing user authority information for each of the items arranged in the form image data, and the client terminal comprises: a receiving unit that receives the form image data and the authority information data from the management server; an authentication unit that performs user authentication and generates user authentication information; an output image generation unit that generates output form image data in which the areas corresponding to one or more of the input items contained in the form image data have been masked, based on the user authentication information and user authority information regarding referencing contained in the authority information data; a reading image generation unit that reads, using the image reading unit, a recording medium on which an image has been formed based on the output form image data and onto which a user has written, thereby generating reading form image data; an area image extraction unit that extracts an area image corresponding to a predetermined item arranged in the reading form image data, based on the user authentication information and user authority information regarding editing contained in the authority information data; and a composite image generation unit that generates composite form image data based on the extracted area image and the form image data.

The present invention provides a technique for solving at least one of the abovementioned problems in a workflow that includes processing using paper-based forms.

Further features of the present invention will become apparent from the following description of an exemplary embodiment (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating an example of the overall course of processing in a workflow according to a first embodiment.

FIG. 2 is a flowchart illustrating the overall course of processing in a workflow according to the first embodiment.

FIG. 3 is a diagram illustrating the overall flow of image data and a form in a workflow according to the first embodiment.

FIG. 4 is a diagram illustrating the overall flow of image data and a form in a workflow according to a third embodiment.

FIG. 5 is a diagram illustrating the configuration of a workflow system according to the first embodiment.

FIG. 6 is a flowchart illustrating the course of processing of a workflow server according to the first embodiment.

FIG. 7 is a flowchart illustrating the course of processing by which a multi-function peripheral prints a form according to the first embodiment.

FIG. 8 is a flowchart illustrating the course of processing by which a multi-function peripheral reads a form according to the first embodiment.

FIG. 9 is a diagram illustrating the configuration of a workflow system according to a second embodiment.

FIG. 10 is a flowchart illustrating the course of processing by which a multi-function peripheral prints a form according to the second embodiment.

FIG. 11 is a flowchart illustrating the course of processing by which a multi-function peripheral reads a form according to the second embodiment.

FIG. 12 is a diagram illustrating the configuration of a workflow system according to the third embodiment.

FIG. 13 is a flowchart illustrating the course of processing of a workflow server according to the third embodiment.

FIG. 14 is a flowchart illustrating the course of processing by which a multi-function peripheral prints a form according to the third embodiment.

FIG. 15 is a flowchart illustrating the course of processing by which a multi-function peripheral reads a form according to the third embodiment.

FIG. 16 is a diagram illustrating an example of overwriting image data with a blank image.

FIG. 17 is a diagram illustrating an example of overwriting image data with an extracted image.

FIG. 18 is a diagram illustrating an example of embedding a barcode in image data.

FIG. 19 is a diagram illustrating an example of embedding a blank image in a barcode area.

FIG. 20 is a diagram illustrating an example of authority setting image area information.

FIG. 21 is a diagram illustrating an example of a reference authority management table.

FIG. 22 is a diagram illustrating an example of an editing authority management table.

FIG. 23 is a diagram illustrating a reference authority management table according to the third embodiment.

FIG. 24 is a diagram illustrating a editing authority management table according to the third embodiment.

FIG. 25 is a diagram illustrating an example of a progress management table.

### DESCRIPTION OF THE EMBODIMENTS

Hereinafter, exemplary preferred embodiments of the present invention shall be described in detail with reference to the diagrams. However, it should be noted that the following embodiments are to be taken as examples only; the scope of the present invention is not intended to be limited by the individual embodiments described hereinafter.

### First Embodiment

A processing system used in a purchasing workflow shall be described in detail hereinafter as an example of a first embodiment of an information processing apparatus according to the present invention.

<Purchase Processing Workflow (Outline)>

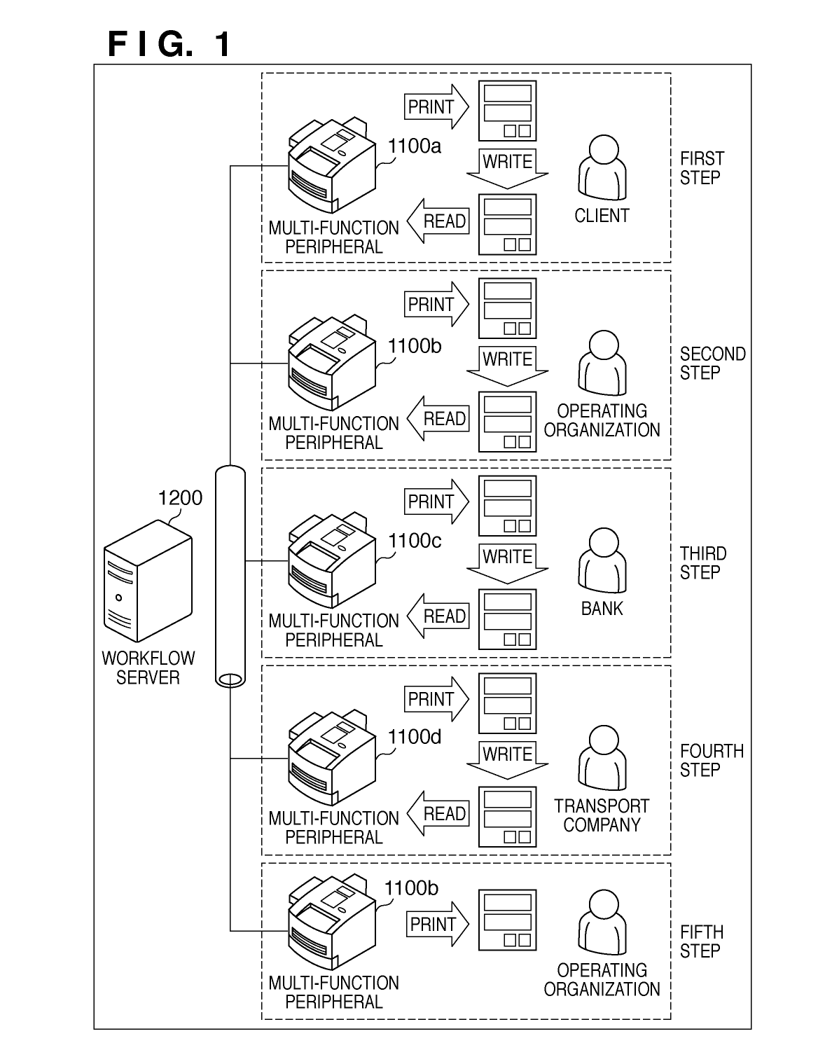

FIG. 1 is a diagram illustrating an example of the overall course of processing in a purchasing workflow according to the first embodiment. Here, the workflow described is one in which a “client” performs an application to purchase a product using a purchase system operated by an “operating organization”, performs a process for depositing money into a bank, and a “transport company” performs a process for transporting the product to the client. In each step, a form is printed and output by a multi-function peripheral; the user fills out the necessary items in the output form, and the filled-out form is then read by the multi-function peripheral. Hereinafter, the electronic data representing the image of the form shall be called “image data”, whereas the paper-based form, obtained through printing onto paper, shall be called simply a “form”.

<Apparatus Configuration>

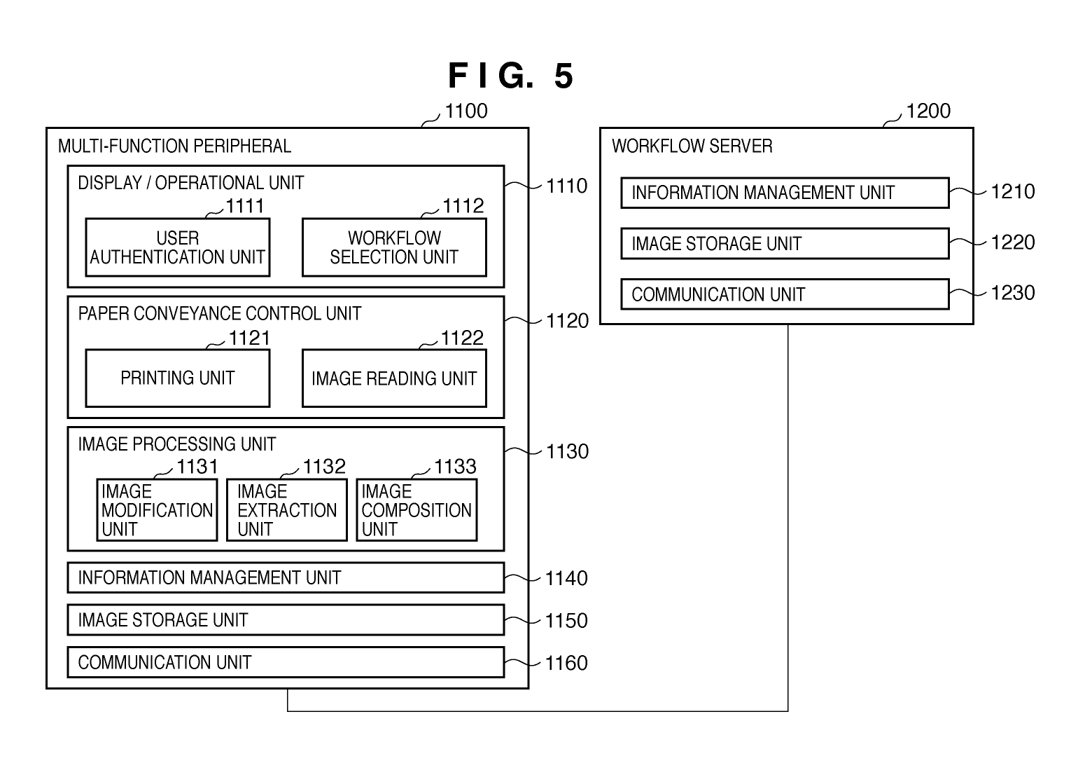

FIG. 5 is a diagram illustrating the configuration of a workflow processing system according to the first embodiment.

A multi-function peripheral 1100 (client terminal) and a workflow server 1200 (management server) are connected to each other via a network.

The workflow server 1200 includes an information management unit 1210, an image storage unit 1220, and a communication unit 1230.

The information management unit 1210 holds authority setting image area information for the image data, a reference authority management table, an editing authority management table, and a progress management table.

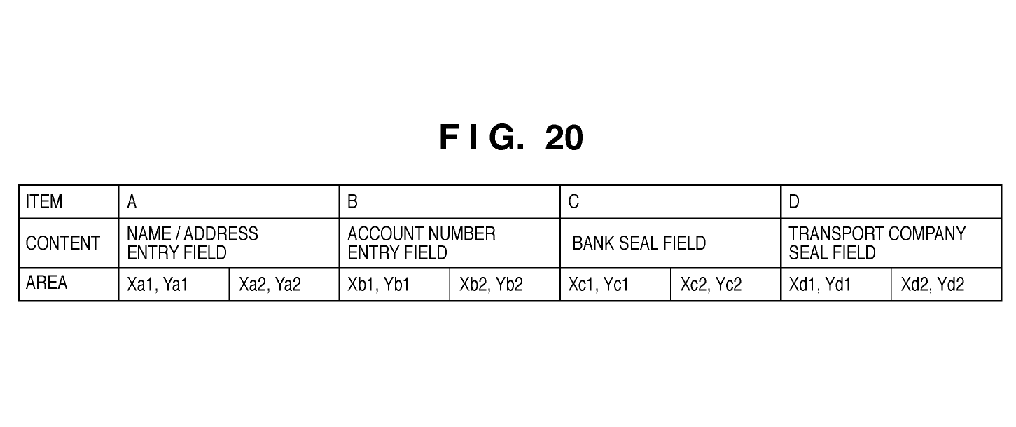

FIG. 20 is a diagram illustrating an example of the authority setting image area information. The authority setting image area information is information indicating image areas on the form that correspond to respective items for which authorities are to be set. Although here, each area is expressed as a rectangular area and the rectangular area is defined by the coordinates of two corners diagonally opposite to each other, it should be noted that any method of denotation may be used as long as it can express an area.

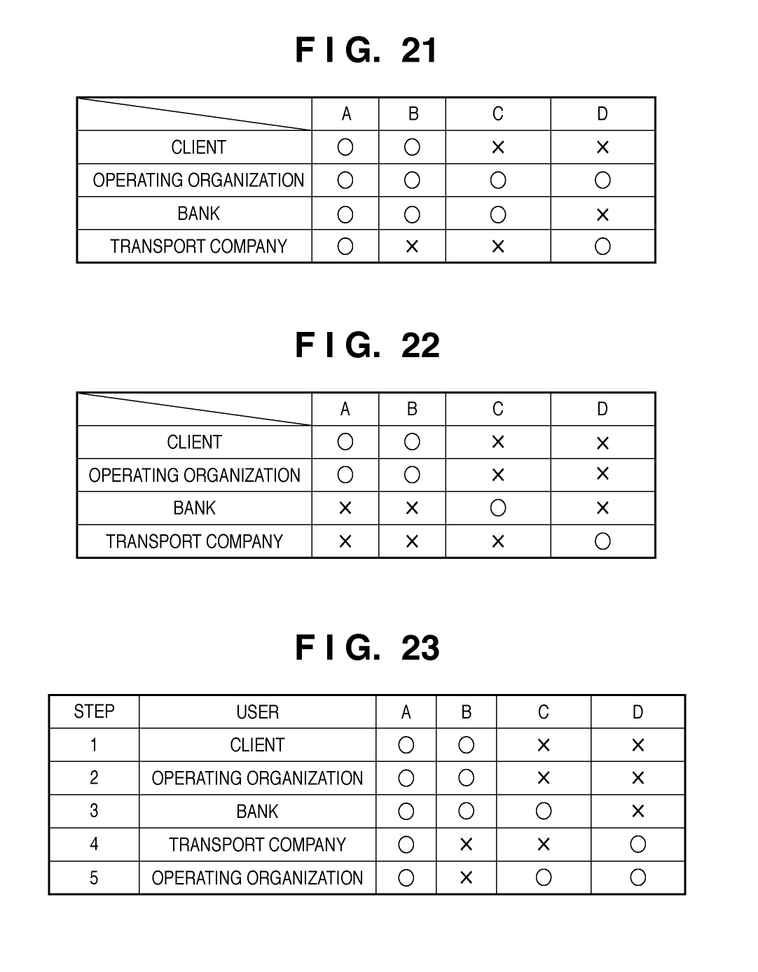

FIG. 21 is a diagram illustrating an example of the reference authority management table. The reference authority management table holds authority information data including user authority information indicating whether or not the respective users in each step can refer to various items on the form. An “◯” in the table indicates that referring is permitted, whereas an “×” indicates that referring is prohibited. FIG. 22 is a diagram illustrating an example of an editing authority management table. The editing authority management table holds authority information data including user authority information indicating whether or not the respective users in each step can edit various items on the form. An “◯” in the table indicates that editing is permitted, whereas an “×” indicates that editing is prohibited.

FIG. 25 is a diagram illustrating an example of a progress management table. The progress management table holds data for managing how far the processing of the workflow in question has proceeded at that point in time.

The image storage unit 1220 holds image data to be sent to multi-function peripherals and image data received from multi-function peripherals.

The multi-function peripheral 1100 includes a display/operational unit 1110, a paper conveyance control unit 1120, an image processing unit 1130, an information management unit 1140, an image storage unit 1150, and a communication unit 1160.

The display/operational unit 1110, meanwhile, includes a user authentication unit 1111 that performs user authentication and a workflow selection unit 1112 that selects the workflow to be executed. The paper conveyance control unit 1120 includes a printing unit 1121 that prints out forms and an image reading unit 1122 that reads images of forms. The image processing unit 1130 includes an image modification unit 1131, an image extraction unit 1132, and an image composition unit 1133. The image modification unit 1131 is a functional unit that performs various modification processes on the image data of a form when the form is printed out. The image extraction unit 1132, meanwhile, is a functional unit that extracts an image of a predetermined necessary area from the image data read by the image reading unit 1122. Finally, the image composition unit 1133 is a functional unit that overwrites the image data extracted by the image extraction unit 1132 onto the image data of the form.

The information management unit 1140 holds data related to workflows, such as authority setting image area information, the reference authority management table, the editing authority management table, and so on, for image data.

The image storage unit 1150 is capable of holding image data to be sent/received to/from the workflow server, image data for printing or scanning forms, and so on. The communication unit 1160 is capable of sending/receiving data to/from the workflow server via a network.

<Apparatus Operations>

Workflow Server Operations

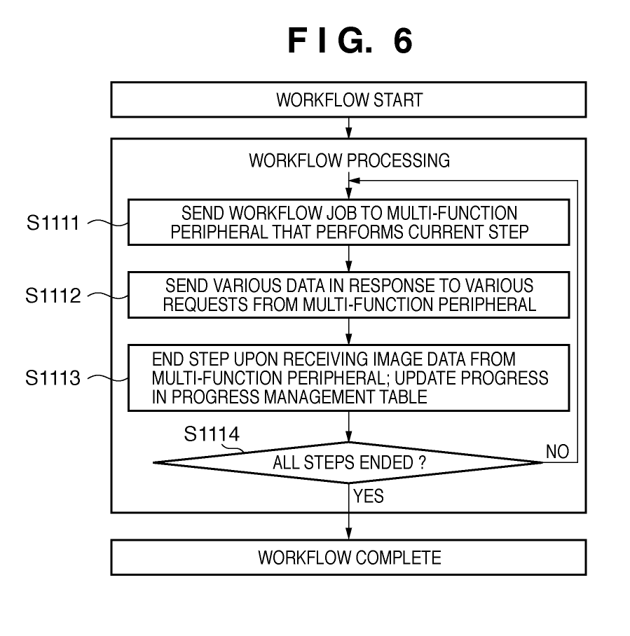

FIG. 6 is a flowchart illustrating the course of processing of a workflow server according to the first embodiment. Note that the operations described hereinafter are realized by, for example, the workflow server executing a workflow management program.

In step S1111, the workflow server refers to the progress management table located in the information management unit 1210, and sends a workflow job, which communicates the start of a workflow step, to a multi-function peripheral that has a step denoted as “unprocessed”. For example, when a workflow is newly commenced, the workflow job is sent to the multi-function peripheral that executes the first step.

In step S1112, the workflow server sends the authority setting image area information, reference authority management table, editing authority management table, and workflow image data in response to a request made by the multi-function peripheral to which the workflow job was sent in step S1111.

In step S1113, the workflow server receives the workflow image data from the multi-function peripheral that has completed its processing, and updates the image data in the image storage unit using the received image data. The progress management table is updated as well.

In step S1114, the workflow server checks whether or not any unprocessed steps remain. In the case where such a step remains, the procedure returns to step S1111, and when all steps have ended, the workflow is considered complete.

Multi-Function Peripheral Operations

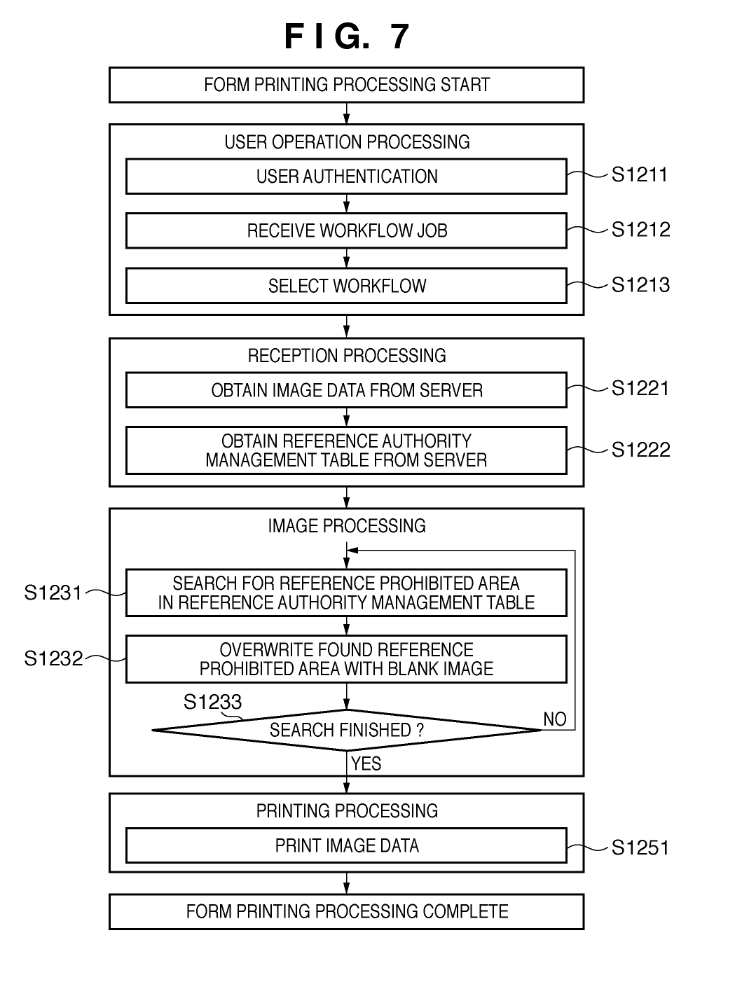

FIG. 7 is a flowchart illustrating the course of processing by which a multi-function peripheral prints a form according to the first embodiment. This flow can be roughly divided into (1) user operation processing, (2) reception processing, (3) image processing, and (4) printing processing.

(1) User Operation Processing

In step S1211, the multi-function peripheral accepts operations made by a user via the display/operational unit 1110 of the multi-function peripheral, authenticates the user, and generates user authentication information for identifying the user. If the user authentication is successful, in step S1212, the multi-function peripheral displays the workflows that can be processed at that point in time in the display/operational unit 1110. Then, in step S1213, the multi-function peripheral accepts a selection for printing a workflow form from the user via the display/operational unit 1110.

(2) Reception Processing

When the user selects workflow form printing, the multi-function peripheral performs a reception process.

In step S1221, the multi-function peripheral requests the workflow server 1200, which is an external apparatus, to send the image data of the selected workflow. When the image data has been received from the workflow server 1200, the multi-function peripheral saves the received image data in the image storage unit 1150. In step S1222, the multi-function peripheral requests that the authority setting image area information and reference authority management table for the selected workflow be sent. Upon receiving the authority setting image area information and the reference authority management table from the workflow server 1200, the multi-function peripheral saves those data items in the information management unit 1140.

(3) Image Modification Processing

In step S1231, the multi-function peripheral refers to the authority settings for the current user in the reference authority management table starting with the record at the top, and searches for items for which reference is prohibited. In the case where an image area for which reference is prohibited is present, in step S1232, the image modification unit 1131 performs a modification process on the workflow image data saved in the image storage unit 1150 (an output image generation unit). To be more specific, in the image data, a blank image is overwritten onto the image area of the item for which reference is prohibited (i.e., the item is masked) based on the authority setting image area information. In step S1233, it is determined whether or not all authority setting records for the current user have been checked, and in the case where an unchecked record remains, the procedure returns to step S1231. Output form image data is generated in this manner.

(4) Printing Processing

In step S1251, the multi-function peripheral prints (forms) the image data located in the image storage unit 1150 onto a recording medium such as paper using the printing unit 1121 (image forming unit).

When the abovementioned (1) user operation processing, (2) reception processing, (3) image processing, and (4) printing processing have ended, the form printing process is considered complete. The user then enters the items necessary in the current step into the printed-out form by hand, for example. After this, the multi-function peripheral reads the form on which the additions (handwritten entries, seals, and so on) have been completed by the user through the flow described below.

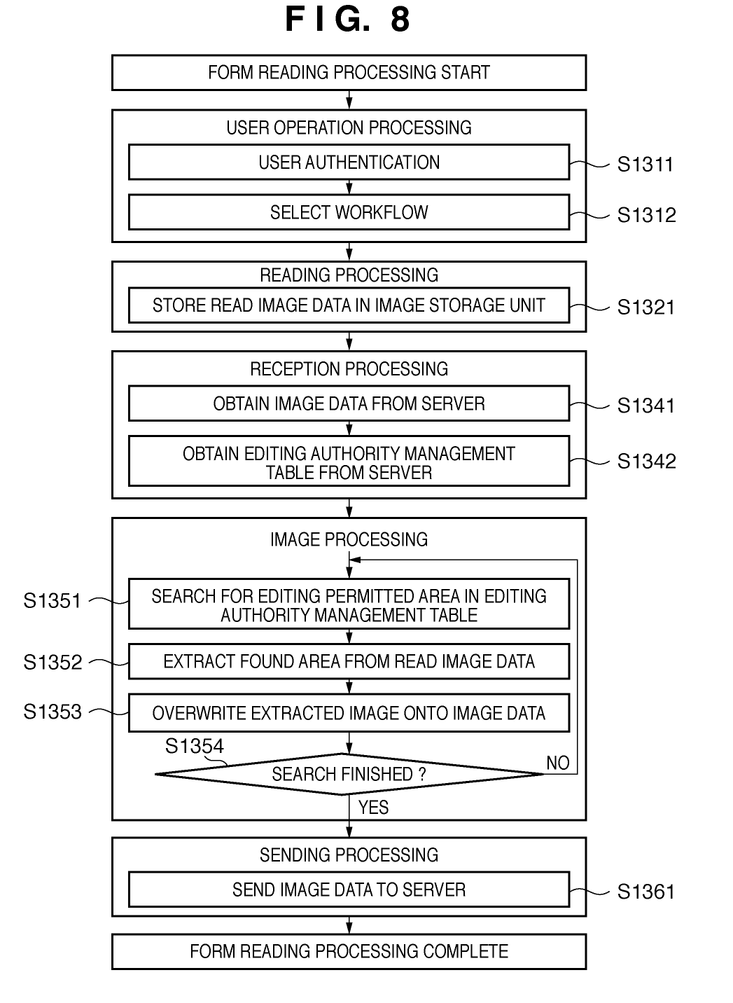

FIG. 8 is a flowchart illustrating the course of processing by which a multi-function peripheral reads a form according to the first embodiment. This flow can be roughly divided into (1′) user operation processing, (2′) reading processing, (3′) reception processing, (4′) image processing, and (5′) sending processing.

(1′) User Operation Processing

In step S1311, the multi-function peripheral accepts operations made by a user via the display/operational unit 1110 of the multi-function peripheral, and authenticates the user. If the user authentication is successful, in step S1312, the multi-function peripheral displays the workflows that can be processed at that point in time in the display/operational unit 1110. Then, the multi-function peripheral accepts a selection for reading a workflow form from the user via the display/operational unit 1110.

(2′) Reading Processing

When the user selects workflow form reading, the multi-function peripheral 1100 moves to a reading process.

In step S1321, the multi-function peripheral 1100 prompts the user, via the display/operational unit 1110, to set the form so as to be readable. The image reading unit 1122 then reads the set form, generates image data (read form image data), and saves that data in the image storage unit 1150 (a reading image generation unit).

(3′) Reception Processing

In step S1341, the multi-function peripheral requests the workflow server 1200 to send the image data of the workflow selected in step S1312, and saves the image data received as a result in the image storage unit 1150.

In step S1342, the multi-function peripheral requests the workflow server 1200 to send the authority setting image area information and the editing authority management table for the image data received in step S1341, and saves the authority setting image area information and the editing authority management table received as a result in the information management unit 1140.

Note that when the same multi-function peripheral as the multi-function peripheral that printed the form is used, the image data is already saved in the image storage unit, and thus the stated reception processing may be omitted.

(4′) Image Extraction/Composition Processing

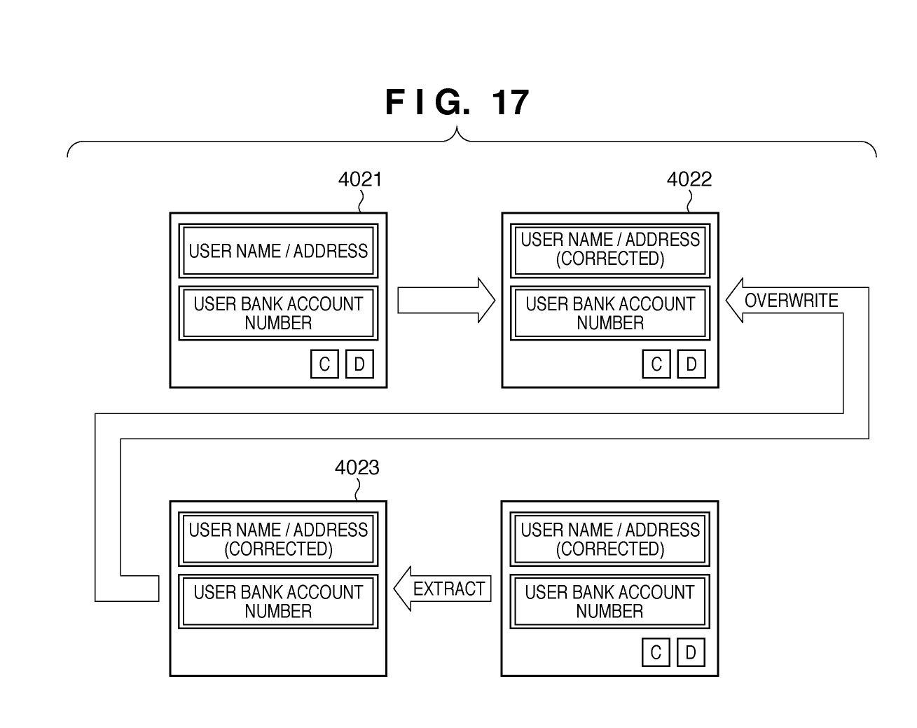

In step S1351, the multi-function peripheral refers to the authority settings for the current user in the editing authority management table starting with the record at the top, and searches for items for which editing is permitted. In the case where an image area for which editing is permitted is present, in step S1352, the image extraction unit 1132 performs an image extraction process on the read image data saved in the image storage unit 1150. To be more specific, in the image data, the area image of the item for which editing is permitted is extracted based on the authority setting image area information (an area image extraction unit). In step S1353, the multi-function peripheral uses the image composition unit 1133 to overwrite (embed) the area image extracted in step S1352 onto (in) the corresponding location in the image data obtained in step S1341 (a composite image generation unit). FIG. 17 is a diagram illustrating an example of overwriting image data with an extracted image (composite form image data). In step S1354, it is determined whether or not all authority setting records for the current user have been checked, and in the case where an unchecked record remains, the procedure returns to step S1351.

(5′) Sending Processing

In step S1361, the multi-function peripheral sends the image data, located in the image storage unit 1150 and on which the image extraction/overwriting processes have been completed, to the workflow server 1200.

When the abovementioned (1′) user operation processing, (2′) reading processing, (3′) reception processing, (4′) image processing, and (5′) sending processing have ended, the form reading process is considered complete.

<Overall Processing Flow>

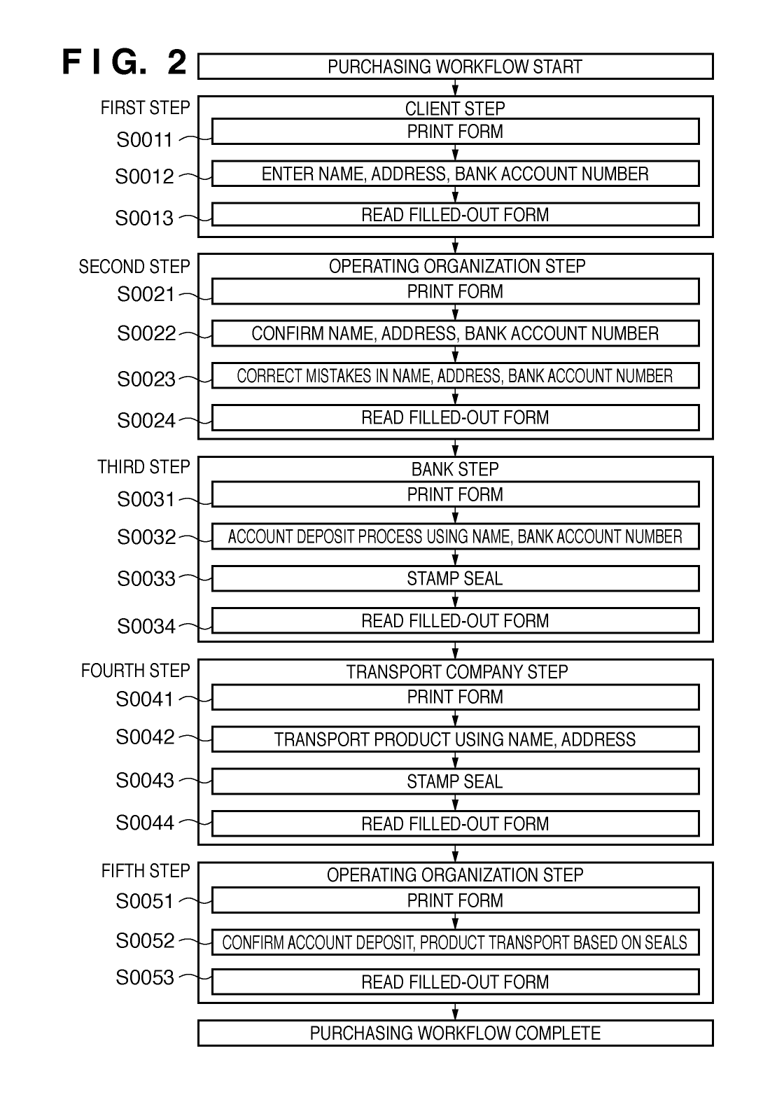

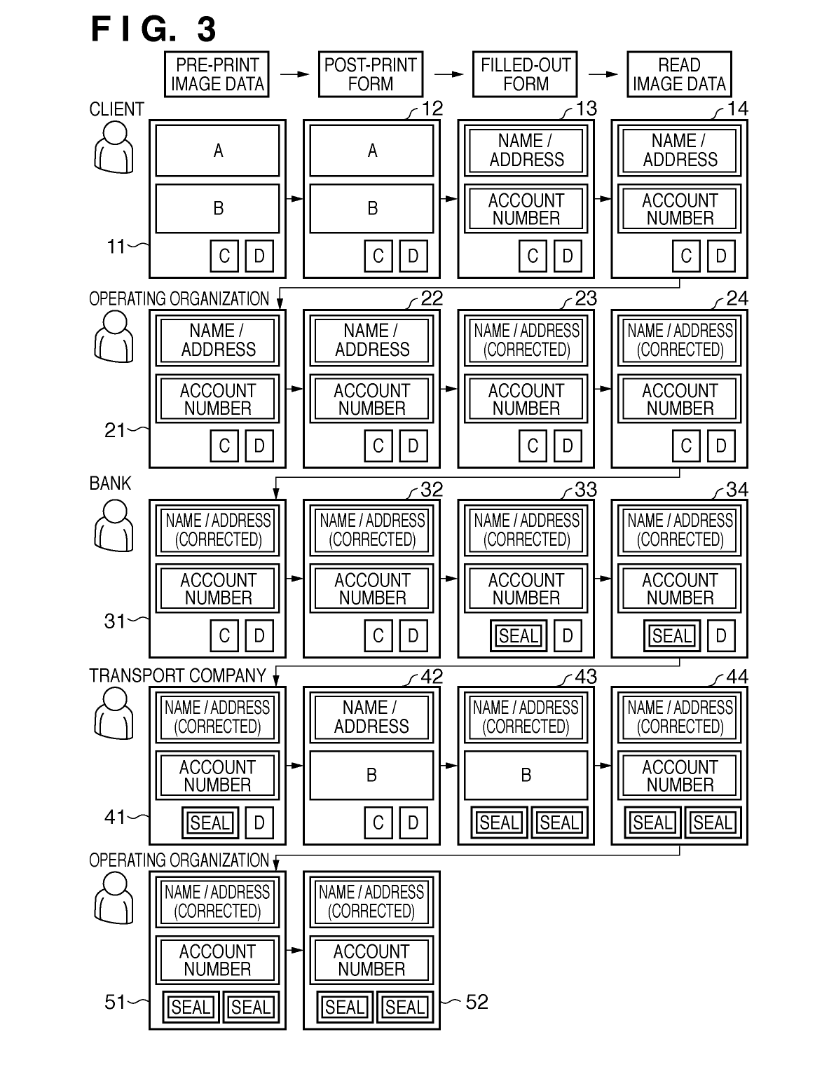

FIG. 2 is a flowchart illustrating the overall course of processing for a workflow according to the first embodiment. FIG. 3, meanwhile, is a diagram illustrating the overall flow of image data and a form in a workflow according to the first embodiment. Here, it is assumed that four input items A through D (that is, one or more input items) are arranged in the form image data, which is the basis of the form.

First Step (Client)

In step S0011, a client user operates a multi-function peripheral and prints a form. Name, address, and bank account number fields appear in the printed form (form 12). In step S0012, the user enters the necessary items in the fields of the form (form 13). After the necessary items have been entered, in step S0013, the filled-out form is read by the multi-function peripheral (image data 14).

Second Step (Operating Organization)

In step S0021, a user in an operating organization operates a multi-function peripheral and prints the form. The name, address, and bank account number entered earlier appear in the printed form (form 22). In step S0022, the user confirms that there are no problems with the entry in the form, and corrects any mistakes if they exist (form 23). After the necessary items have been entered, in step S0023, the filled-out form is read by the multi-function peripheral (image data 24).

Third Step (Bank)

In step S0021, a user in a bank operates a multi-function peripheral and prints the form. The name, address, and bank account number entered earlier, as well as a bank seal field, appear in the printed form (form 32). In step S0032, the user performs an account deposit process based on the information written in the form. The user then stamps the bank seal field with the bank's seal after performing the account deposit process (form 33). After the seal has been stamped, in step S0033, the stamped form is read by the multi-function peripheral (image data 34).

Fourth Step (Transport Company)

In step S0041, a user in the transport company operates a multi-function peripheral and prints the form. The name and address entered earlier, as well as a transport company seal field, appear in the printed form (form 42). In step S0042, the user performs a product transfer process based on the information written in the form. The user then stamps the transport company seal field with the transport company's seal after performing the transport process (form 43). After the seal has been stamped, in step S0043, the stamped form is read by the multi-function peripheral (image data 44).

Fifth Step (Operating Organization)

In step S0051, a user in the operating organization operates a multi-function peripheral and prints the form. The name and address entered earlier, as well as the bank seal field and the transport company seal field, appear in the printed form (form 52). In step S0052, the user confirms that the account deposit process and transport process have been performed, based on the information written in the form. After this confirmation, in step S0053, the form is read by the multi-function peripheral.

When step S0053 ends, the overall workflow is considered complete.

As described thus far, with the workflow processing system according to the first embodiment, it is possible to realize a paper-based workflow that is easy for users to understand and which reduces security-related problems. Specifically, it is possible to realize a paper-based workflow in which, when multiple users are included in the workflow, the referencing/editing of information can be set on a user-by-user basis.

### Second Embodiment

A second embodiment describes an example in which user information, workflow information, and the like are embedded in a form as a barcode image, thereby simplifying the operations performed by the user. Specifically, user authentication and user operations related to workflow selection performed when reading a filled-out form using a multi-function peripheral can be omitted. Although the descriptions given here discuss a barcode, it should be noted that any coded image, such as a text-based code or a QR® code, can be used.

<Apparatus Configuration>

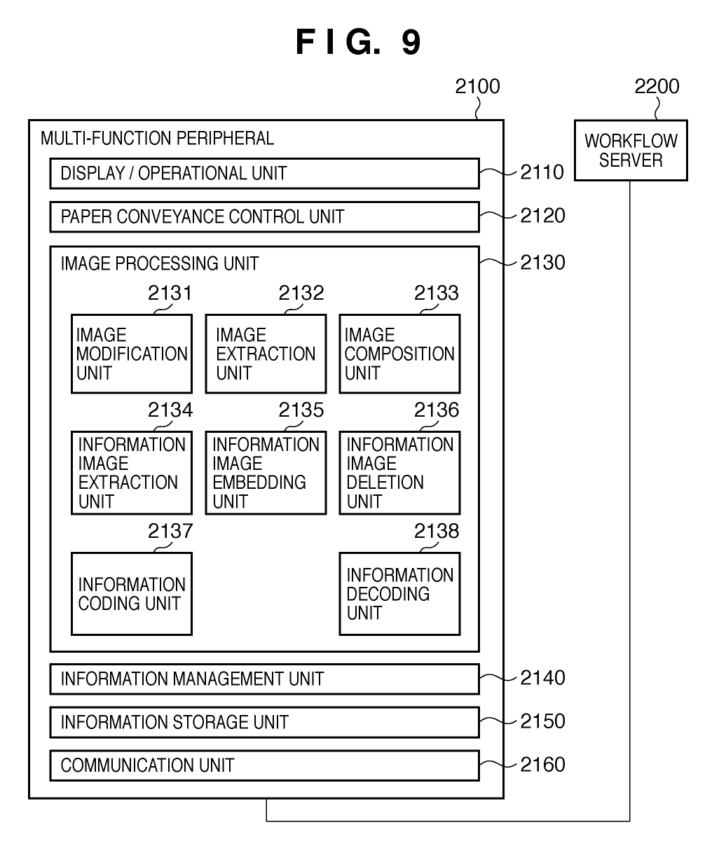

FIG. 9 is a diagram illustrating the configuration of a workflow processing system according to the second embodiment.

A multi-function peripheral 2100 has the same configuration as the multi-function peripheral of the first embodiment, with the exception of an image processing unit 2130.

The image processing unit 2130 includes an information image extraction unit 2134, an information image embedding unit 2135, an information image deletion unit 2136, an information coding unit 2137, and an information decoding unit 2138 in addition to an image modification unit 2131, an image extraction unit 2132, an image composition unit 2133.

The information image extraction unit 2134 is a functional unit that performs a process for extracting a barcode image from a form. The information image embedding unit 2135 is a functional unit that performs a process for embedding a barcode image in a form. The information image deletion unit 2136 is a functional unit that performs a process for deleting an old barcode image from image data. The information coding unit 2137 is a functional unit that generates a barcode based on user information and workflow information. The information decoding unit 2138 is a functional unit that decodes a barcode and obtains the resulting user information and workflow information.

<Apparatus Operations>

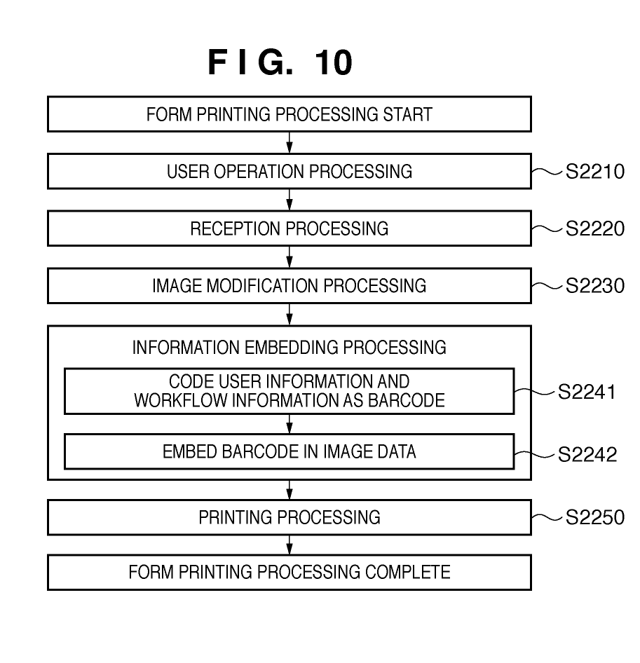

FIG. 10 is a flowchart illustrating the course of processing by which a multi-function peripheral prints a form according to the second embodiment. Note that the presence of (5) information embedding processing between (3) image modification processing and (4) printing processing is the point that differs from the form printing processing of the first embodiment. The information embedding processing shall therefore be described hereinafter.

Multi-Function Peripheral Operations

(5) Information Embedding Processing

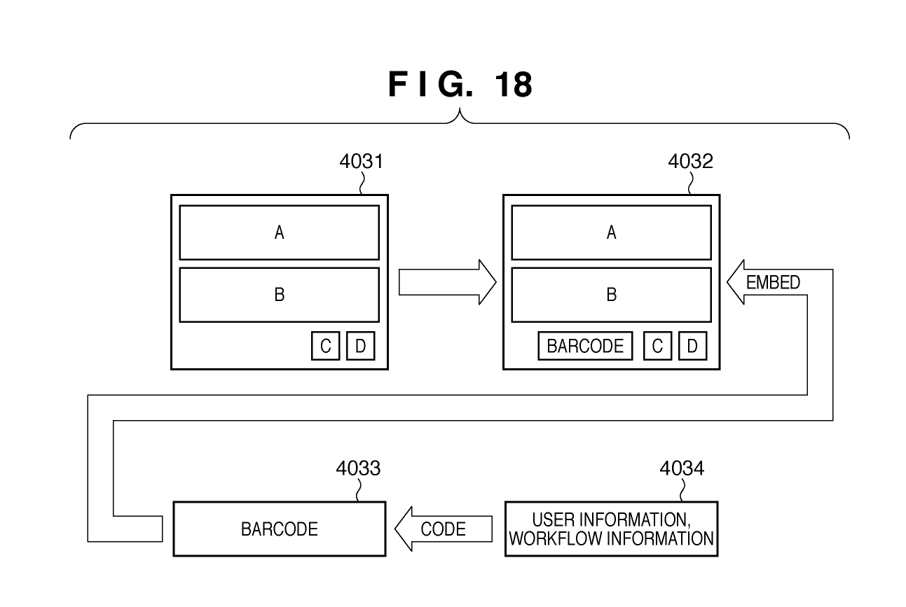

In step S2241, the multi-function peripheral uses the information encoding unit 2137 to generate a barcode image based on user information and workflow information (a coded image generation unit). In step S2242, the generated barcode image is embedded in a predetermined location in the image data stored in the image storage unit 2150 and on which the image modification process has been performed. FIG. 18 is a diagram illustrating an example of embedding the barcode in the image data. After the information embedding processing, in step S2250, the image data in which the barcode has been embedded is printed.

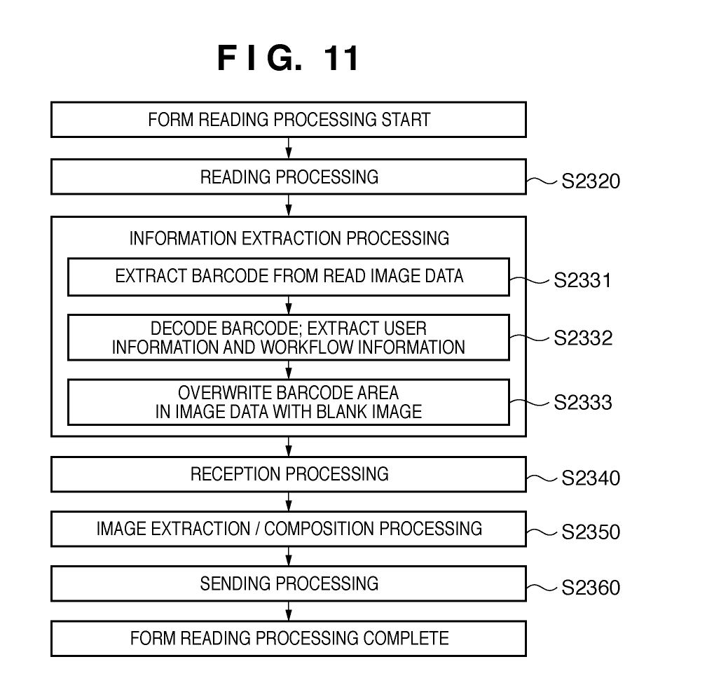

FIG. 11 is a flowchart illustrating the course of processing by which a multi-function peripheral reads a form according to the second embodiment. Note that the presence of (6′) information extraction processing between (2′) reading processing and (3′) reception processing is the point that differs from the form reading processing of the first embodiment. The information extraction processing shall therefore be described hereinafter.

(6′) Information Extraction Processing

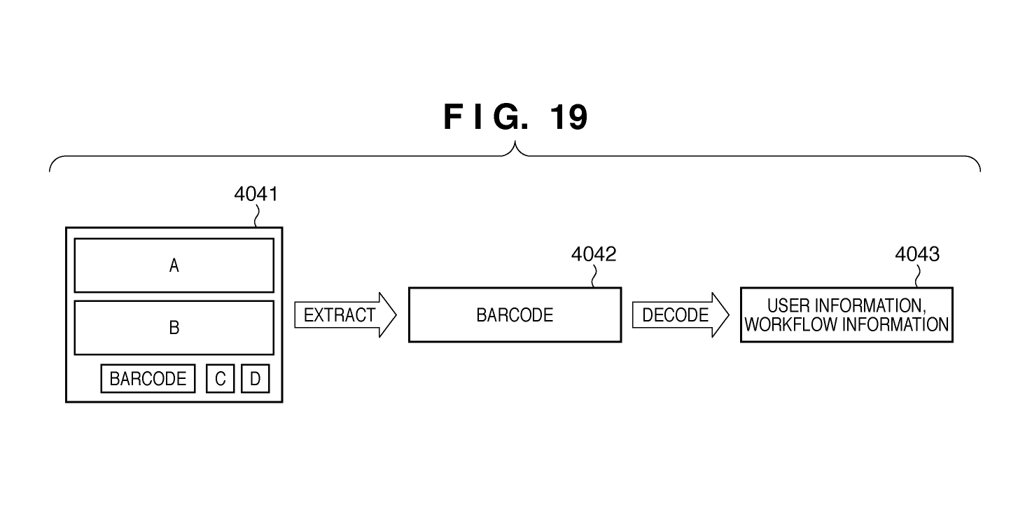

In step S2331, the multi-function peripheral uses the information image extraction unit 2134 to extract a barcode in a predetermined location from the read image stored in an image storage unit 2150. In step S2332, the user information and workflow information is obtained from the extracted barcode (a user information extraction unit). In step S2333, a blank image is embedded in the barcode area in the predetermined location in the read image. FIG. 19 is a diagram illustrating an example of embedding the blank image in the barcode area.

In this manner, generating a barcode image based on user information and workflow information and printing the barcode on a form makes it possible to omit the user authentication and workflow selection when reading the form. The workflow system is therefore easier for the user to use.

### Third Embodiment

A third embodiment describes an example in which reference/editing authorities are changed by making authority settings that factor in the progress of the workflow.

<Apparatus Configuration>

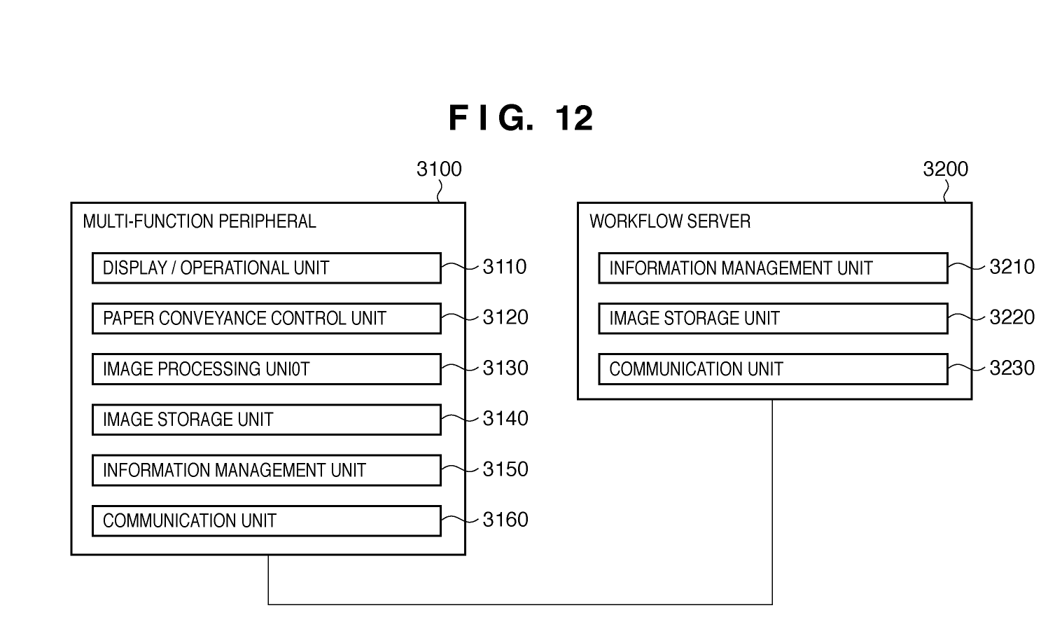

FIG. 12 is a diagram illustrating the configuration of a workflow system according to the third embodiment.

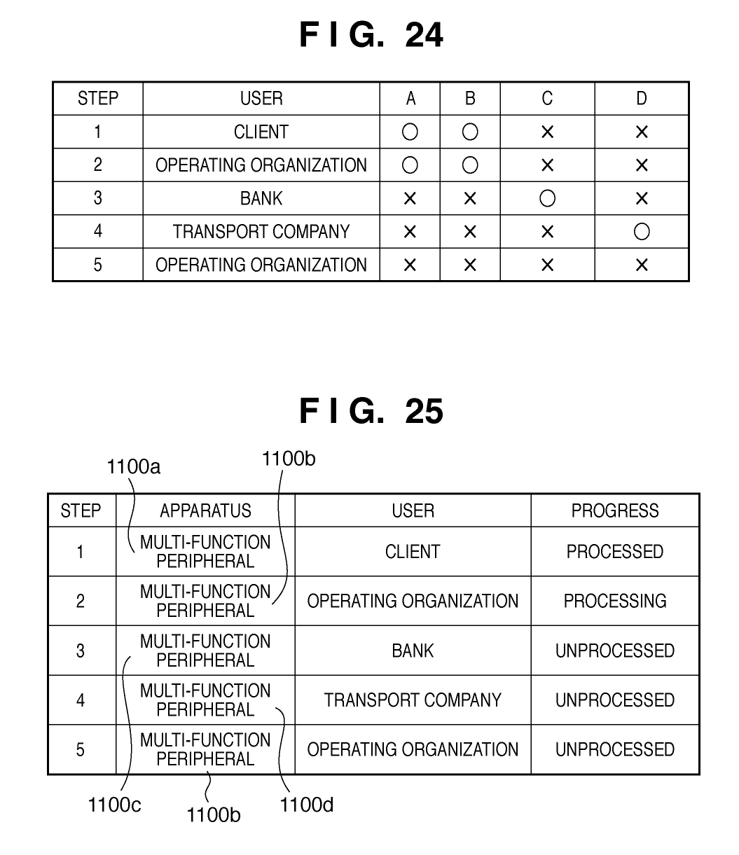

A multi-function peripheral 3100 has the same configuration as the multi-function peripheral of the first embodiment, with the exception of an information management unit 3150. The information management unit 3150 holds authority setting image area information, a reference authority management table, an editing authority management table, and a progress management table, for corresponding image data. FIG. 23 is a diagram illustrating an example of the reference authority management table according to the third embodiment, and FIG. 24 is a diagram illustrating an example of the editing authority management table according to the third embodiment.

A workflow server 3200 has the same configuration as the workflow server of the first embodiment with the exception of an information management unit 3150. The information management unit 3210 holds authority setting image area information, a reference authority management table, an editing authority management table, and a progress management table, for the image data.

<Apparatus Operations>

Workflow Server Operations

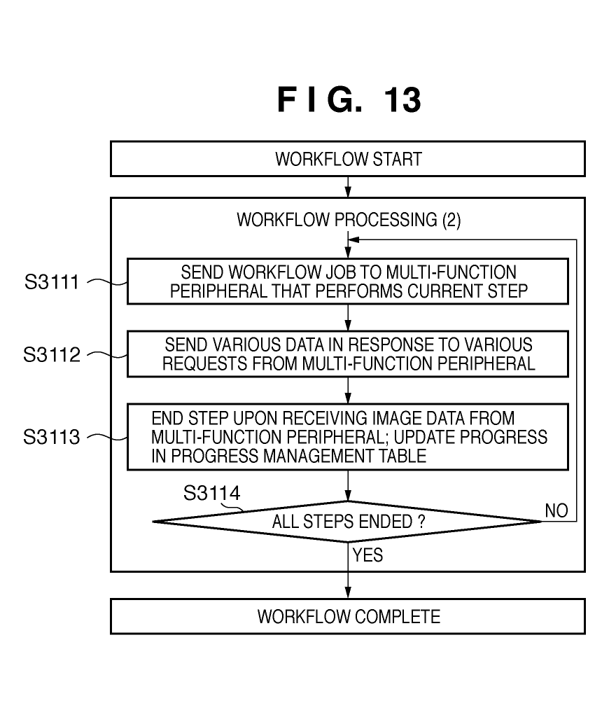

FIG. 13 is a flowchart illustrating the course of processing of a workflow server according to the third embodiment.

In step S3111, the workflow server refers to the progress management table located in an information management unit 3210, and sends a workflow job, which communicates the start of a workflow step, to a multi-function peripheral that has a step denoted as “unprocessed”. For example, when a workflow is newly commenced, the workflow job is sent to the multi-function peripheral that executes the first step.

In step S3112, the workflow server sends the authority setting image area information, reference authority management table, editing authority management table, progress management table, and workflow image data in response to a request made by the multi-function peripheral to which the workflow job was sent.

In step S3113, the workflow server receives the workflow image data from the multi-function peripheral that has completed its processing, and updates the image data in the image storage unit using the received image data. The progress management table is updated as well.

In step S3114, the workflow server checks whether or not any unprocessed steps remain. In the case where such a step remains, the procedure returns to step S3111, and when all steps have ended, the workflow is considered complete.

Multi-Function Peripheral Operations

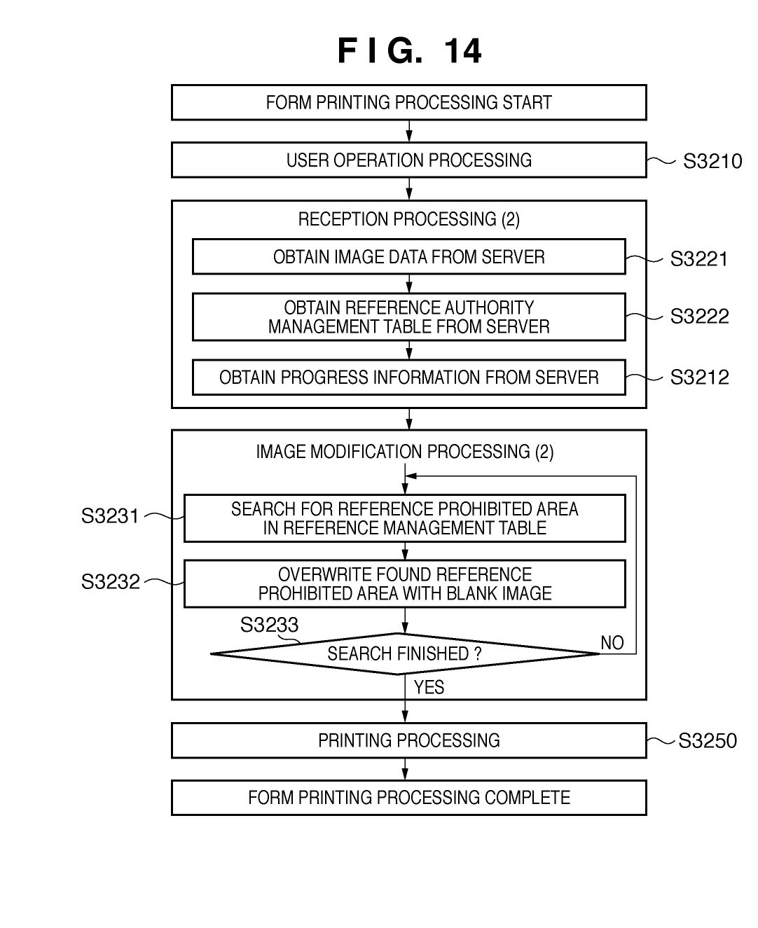

FIG. 14 is a flowchart illustrating the course of processing by which a multi-function peripheral prints a form according to the third embodiment. This processing flow is the same as the form printing processing of the first embodiment, with the exception of (2) reception processing and (3) image modification processing.

(2) Reception Processing

When the user selects workflow form printing, the multi-function peripheral performs a reception process.

In step S3221, the multi-function peripheral requests the workflow server 3200 to send the image data of the selected workflow. When the image data has been received from the workflow server 3200, the multi-function peripheral saves the received image data in an image storage unit 3140. In step S3222, the multi-function peripheral requests that the authority setting image area information, reference authority management table, and progress management table corresponding to the selected workflow be sent. Upon receiving the authority setting image area information, the reference authority management table, and the progress management table from the workflow server 3200, the multi-function peripheral saves those data items in the information management unit 3140.

(3) Image Modification Processing

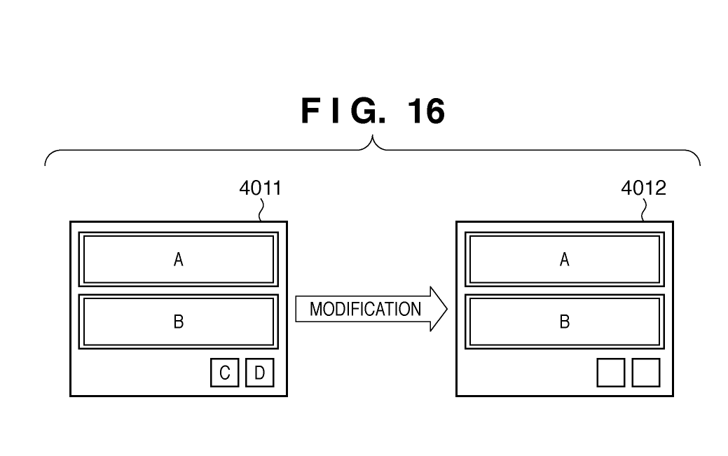

In step S3231, the multi-function peripheral refers to the authority settings for the current user in the reference authority management table starting with the record at the top, and searches for items for which reference is prohibited. In the case where an image area for which reference is prohibited is present, in step S3232, the image modification unit 3131 performs a modification process on the workflow image data saved in the image storage unit 3140. To be more specific, in the image data, a blank image is overwritten onto the image area of the item for which reference is prohibited based on the authority setting image area information. FIG. 16 is a diagram illustrating an example of overwriting image data with a blank image. In step S3233, it is determined whether or not all authority setting records for the current user have been checked, and in the case where an unchecked record remains, the procedure returns to step S3231.

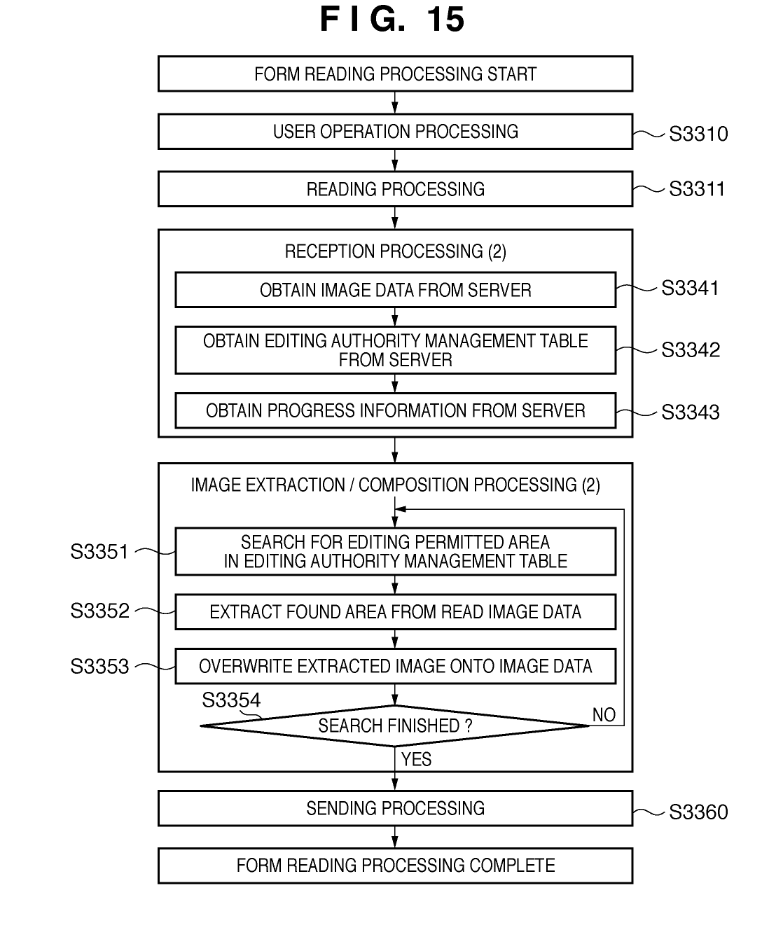

FIG. 15 is a flowchart illustrating the course of processing by which a multi-function peripheral reads a form according to the third embodiment. This processing flow is the same as the form reading processing of the first embodiment, with the exception of (3′) reception processing and (4′) image extraction/composition processing.

(3′) Reception Processing

In step S3341, the multi-function peripheral requests the workflow server 3200 to provide the image data of the selected workflow, and saves the image data received as a result in the image storage unit 3140.

In step S3342, the multi-function peripheral requests the workflow server 3200 to provide the authority setting image area information, editing authority management table, and progress management table corresponding to the received image data. The received authority setting image area information, editing authority management table, and progress management table are then saved in the information management unit 3140.

Note that when the same multi-function peripheral as the multi-function peripheral that printed the form is used, the image data is already saved in the image storage unit, and thus the stated reception processing may be omitted.

(4′) Image Extraction/Composition Processing

In step S3351, the multi-function peripheral refers to the authority settings for the current user in the editing authority management table starting with the record at the top, and searches for items for which editing is permitted. In the case where an image area for which editing is permitted is present, in step S3352, the image extraction unit 3132 performs an image extraction process on the read image data saved in the image storage unit 3140. To be more specific, in the image data, the area image of the item for which editing is permitted is extracted based on the authority setting image area information. In step S3353, the multi-function peripheral uses an image composition unit 3133 to overwrite (embed) the area image extracted in step S3352 onto (in) the corresponding location in the image data obtained in step S3341. In step S3354, it is determined whether or not all authority setting records for the current user have been checked, and in the case where an unchecked record remains, the procedure returns to step S3351.

<Overall Processing Flow>

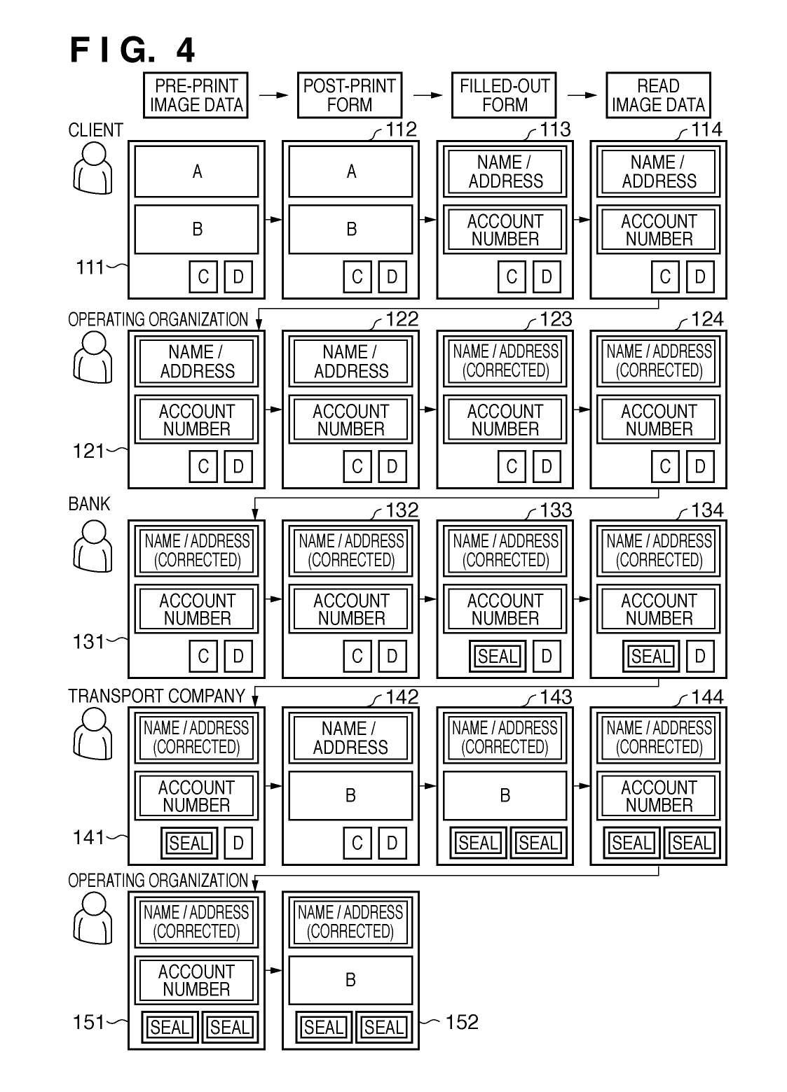

FIG. 4 is a diagram illustrating the overall flow of image data and a form in a workflow according to the third embodiment.

The bank account number of the client is displayed in form 122 held by the operating organization in the second step. However, the bank account number of the client is hidden in form 152 in the fifth step. In other words, it is possible to change the reference information from step to step, even if the user is the same.

As described above, with the workflow system according to the third embodiment, it is possible to change the reference/editing authorities even in the case where the same user performs multiple steps.

### Other Embodiments

Although embodiments of the present invention have been described in detail thus far, note that the present invention may be applied in a system configured of multiple devices, or may be applied in an apparatus composed of a single device.

The present invention can also be achieved by directly or remotely supplying a program that realizes the functionality of the abovementioned embodiments to a system or device, whereupon that system or device reads out and executes the supplied program code. Accordingly, the program code itself, installed in a computer so as to realize the functional processing of the present invention through a computer, is also included in the technical scope of the present invention.

In this case, the program may be in any form, and object code, a program executed through an interpreter, script data supplied to an OS, or the like may be used, as long as it has the functionality of the program.

Examples of a recording medium that can be used to supply the program code include Floppy® disks, hard disks, optical disks (CDs, DVDs), magneto-optical disks, magnetic tape, non-volatile memory cards, and ROMs.

Furthermore, the program read out from the recording medium may be written into a memory provided in a function expansion board installed in the computer or a function expansion unit connected to the computer. After this, a CPU or the like provided in the function expansion board, function expansion unit, or the like executes part or all of the actual processing based on instructions from the program, and the functionality of the aforementioned embodiments can be realized through this processing.

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2008-146217, filed Jun. 3, 2008, which is hereby incorporated by reference herein in its entirety.

What is claimed is:

1. An information processing apparatus, comprising:
a receiving unit that receives, from an external apparatus, form image data in which multiple input items have been arranged in advance and authority information data containing user authority information for each of the items arranged in the form image data;
an authentication unit that performs user authentication and generates user authentication information; and
an output image generation unit that generates output form image data in which the areas corresponding to one or more of the input items contained in the form image data have been masked, based on the user authentication information and user authority information regarding referencing contained in the authority information data.

2. The information processing apparatus according to claim 1, wherein the information processing apparatus comprises an image forming unit that forms an image upon a recording medium based on the form image data and an image reading unit that reads a form that has been written on by a user, and
the image processing apparatus further comprises:
a reading image generation unit that reads, using the image reading unit, a recording medium on which an image has been formed based on the output form image data and onto which a user has written, thereby generating reading form image data;
an area image extraction unit that extracts an area image corresponding to a predetermined item arranged in the reading form image data, based on the user authentication information and user authority information regarding editing contained in the authority information data; and
a composite image generation unit that generates composite form image data based on the extracted area image and the form image data.

3. The information processing apparatus according to claim 2, wherein the output image generation unit includes:
a coded image generation unit that generates a coded image based on at least user information identified by the authentication unit; and
an image embedding unit that embeds the coded image in the output form image data.

4. The information processing apparatus according to claim 3,
wherein the reading image generation unit includes a user information extraction unit that reads a recording medium onto which an image has been formed based on the output form image data in which the coded image has been embedded, and extracts user information from the coded image; and
the user information extraction unit sets the user authentication information based on the extracted user information.

5. A control method for an information processing apparatus, the method comprising the steps of:
receiving, from an external apparatus, form image data in which multiple input items have been arranged in advance and authority information data containing user authority information for each of the items arranged in the form image data;
performing user authentication and generating user authentication information; and
generating output form image data in which the areas corresponding to one or more of the input items contained in the form image data have been masked, based on the user authentication information and user authority information regarding referencing contained in the authority information data.

6. The control method for an information processing apparatus according to claim 5,
wherein the information processing apparatus comprises an image forming unit that forms an image upon a recording medium based on the form image data, and an image reading unit that reads a form that has been written on by a user, and
the method further comprises the steps of:
reading, using the image reading unit, a recording medium on which an image has been formed based on the output form image data and onto which a user has written, thereby generating reading form image data;
extracting an area image corresponding to a predetermined item arranged in the reading form image data, based on the user authentication information and user authority information regarding editing contained in the authority information data; and
generating composite form image data based on the extracted area image and the form image data.

7. A workflow processing system including a management server that manages workflow processing, and a client terminal comprising an image forming unit and an image reading unit, the management server and the client terminal being connected to each other via a network,
wherein the management server comprises:
a management unit that manages form image data in which multiple input items have been arranged in advance and authority information data containing user authority information for each of the items arranged in the form image data, and
the client terminal comprises:
a receiving unit that receives the form image data and the authority information data from the management server;
an authentication unit that performs user authentication and generates user authentication information;
an output image generation unit that generates output form image data in which the areas corresponding to one or more of the input items contained in the form image data have been masked, based on the user authentication information and user authority information regarding referencing contained in the authority information data;
a reading image generation unit that reads, using the image reading unit, a recording medium on which an image has been formed based on the output form image data and onto which a user has written, thereby generating reading form image data;
an area image extraction unit that extracts an area image corresponding to a predetermined item arranged in the reading form image data, based on the user authentication information and user authority information regarding editing contained in the authority information data; and
a composite image generation unit that generates composite form image data based on the extracted area image and the form image data.
